(19) United States
(12) Patent Application Publication
(10) Pub. No.: US 2026/0111528 A1
(43) Pub. Date: Apr. 23, 2026

(54) SYSTEM AND METHOD FOR MANAGING OPERATIVELY COUPLING AND SECURITY IN A WORKSPACE VIA A USER QUERY INPUT AND MODIFYING ARTIFICIAL INTELLIGENCE OUTPUT BASED ON DETECTED DEVICES IN THE WORKSPACE

(71) Applicant: Dell Products LP, Round Rock, TX (US)

(72) Inventors: Daniel L. Hamlin, Round Rock, TX (US); Srikanth Kondapi, Austin, TX (US); Balasingh Ponraj Samuel, Round Rock, TX (US)

(73) Assignee: Dell Products LP, Round Rock, TX (US)

(21) Appl. No.: 18/920,870

(22) Filed: Oct. 19, 2024

(51) Int. Cl. G06F 21/44

(52) U.S. Cl. CPC G06F 21/44

(57) ABSTRACT

A system and method of executing code instructions for an artificial intelligence (AI) productivity tool software module comprising a hardware processor receiving user-query input and receiving location data describing a current location and identification of personal area network (PAN) devices at a workspace. With historic information handling system usage data, identification of the PAN devices and the user query input, the hardware processor executing code instructions of a PAN device preferences AI software application to identify a capability intent semantically matched with the user-query input, the identification of the PAN devices, and the historic information handling system usage patterns to identify a responsive capability to automatically select and operably couple the information handling system and one or more of the identified PAN devices in response to the user query input, including meeting security communication policies for the information handling system and the PAN devices.

### FIELD OF THE DISCLOSURE

The present disclosure generally relates to execution of computer-readable program code instructions for one or more artificial intelligence (AI) productivity tools generating responsive actions to user-query inputs. The present disclosure more specifically relates systems and methods of establishing a logical trust relationship with personal area network (PAN) connected devices within a workspace on behalf of an information handling system with the AI productivity tool in response to the user-query inputs.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications or other application such as for teleconferencing, word processing, sales systems, business software, gaming applications, or the like. Further, the information handling system may include an on the box (OTB) artificial intelligence (AI) productivity tool employing machine learning (ML) models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes computer-readable program code instructions of an AI productivity tool and a PAN device preferences AI software application to select among capabilities for a plurality of AI productivity tool-enablable software applications for establishing operative coupling with PAN connected devices in a workspace for the information handling system according to an embodiment of the present disclosure;

FIG. 2 is a graphic and block diagram illustrating an information handling system that includes computer-readable program code instructions of an AI productivity tool and a PAN device preferences AI software application to select among capabilities for a plurality of AI productivity tool-enablable software applications for establishing a logical trust relationship and operatively coupling with one or more PAN connected devices in a workspace for the information handling system according to an embodiment of the present disclosure; and

FIG. 3 is a flow diagram showing a method executing computer-readable program code instructions of an AI productivity tool and a PAN device preferences AI software application to select among capabilities for a plurality of AI productivity tool-enablable software applications for establishing a logical trust relationship and operative coupling with one or more PAN connected devices in a workspace for the information handling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems, including computers, mobile computers, and smart phones are increasingly employing artificial intelligence (AI) productivity tools to optimize user productivity and performance of the information handling systems. Examples of such artificial intelligence methodologies includes chatbots to simulate conversations between the information handling system and the user. In an example embodiment of the present disclosure, an AI productivity tool may be used to trigger changes in firmware or hardware (e.g., changing display or power settings, establish a wireless coupling), software, or processes of one or more AI productivity tool-enablable software applications (e.g., send an e-mail or text message, schedule a meeting). Various machine learning models may be used to support such functionality, including automatic speech recognition (ASR) models, text embedding models, and similarity search models that may work in combination with one another to identify a capability intent action that may be taken by an AI productivity tool enablable software application as requested within a received user-query input according to embodiments herein.

For example, an existing AI productivity tool may be capable of determining a user's intent for correlation to a capability intent action the user is requesting to be performed within a user-query input, and matching that determined query intent with a capability intent known to be achievable, based on published or established capabilities by a particular of one or more AI productivity tool-enablable software applications (e.g., pre-registered capabilities) executing at the information handling system. In some AI productivity tools, once the AI productivity tool-enablable software application capable of performing the user-requested capability intent action within the user-query input is identified, the AI productivity tools may identify an application programming interface (API) call that, when executed, may cause the AI productivity tool-enablable software application associated with the identified capability to perform that capability. In some embodiments, a user query input may request operatively coupling with one or more external peripheral devices, such as within a user workspace, that requires wireless or operative coupling and raises potential security issues that must be addressed by the AI productivity tool. Further, the AI productivity tool may provide this service to a user via user query input, but may also provide for identification of appropriate selection of external peripheral devices to be used and configuration adjustments of those external peripheral devices or the information handing system within the workspace in embodiments of the present disclosure.

As users of the information handling system move into hybrid work modes, for example, and the information handling system is moved from location to location, the external peripheral devices available or being used at different locations may not be consistent. For example, a user may move a laptop-type information handling system from a home office to a work office, or even to a conference room or to a hoteling office workspace. These various workspaces (e.g., home office, work office, conference room, hoteling office workspace) may each include disparate wired or wireless peripheral devices that could be used by the user and, therefore, operatively couplable to the user's information handling system. AI productivity tools, in some embodiments described herein, may be used to automate the detection of the arrangement of security protocols with, and the operatively coupling to various selections of these external peripheral devices at workspaces in various locations.

The present specification describes systems and methods of establishing a logical trust relationship with PAN devices within a workspace in the embodiments described herein. It is appreciated that these PAN devices may include any external peripheral device within a detected workspace that may be operatively coupled to the user's information handling system such as via any wireless or wired networking operative coupling. The information handling system includes a hardware processor that executes computer-readable program code instructions of an environment device detection and policy software application to receive location data describing a current location of the information handling system and an identification of PAN devices available for use by the information handling system. Additionally, the hardware processor executes computer-readable program code instructions of a historic usage software application to define historic information handling system usage patterns describing how the user has historically used the information handling system, such as software applications executed, hardware components or peripheral devices used, settings, and the like.

In an embodiment, the hardware processor further executes computer-readable program code instructions of a PAN device preferences AI software application to receive the location data, available PAN devices, and the historic information handling system usage patterns. With this data, the hardware processor executing computer-readable program code instructions of an artificial intelligence (AI) productivity tool subagent to receive user-query input from an AI productivity tool software module, the location data, the historic information handling system usage patterns, and identification of available PAN devices in a current workspace. With the user-query input, the location data, and the historic information handling system usage patterns the hardware processor executes a plurality of machine learning (ML) model algorithms to identify an intent associated with the user-query input, identify a capability associated with one or more AI productivity tool-enablable software applications that can execute a capability intent action based on the identified intent and establish a trust relationship between the information handling system and one or more of the identified PAN devices. This system and method utilizes user preferences, performance needs of the information handling system and user, availability of PAN devices, and preferential pairing with the PAN devices for the information handling system to establish a logical trust relationship with a plurality of PAN devices within any detected workspace.

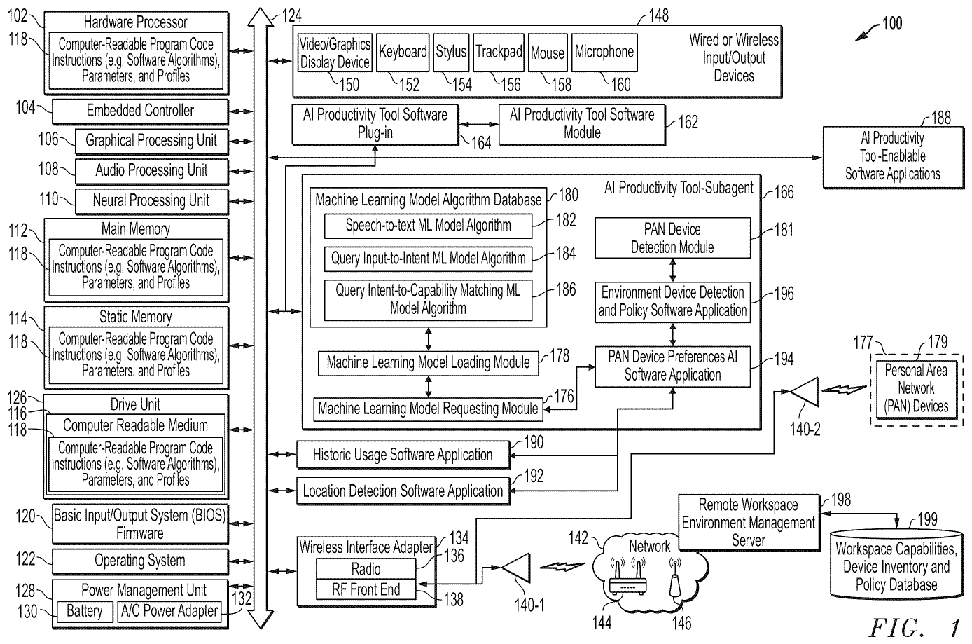

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify capability intent actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be quickly accessible by hardware processing resources using that main memory 112. Computer-readable program code instructions stored in static memory 114, or drive unit 126 may involve some latency in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various input and output (I/O) devices 148, such as a mouse 158, a trackpad 156, a stylus 154, a keyboard 152, a video/graphics display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms), parameters, and profiles 118 that may operate on servers or systems, remote data centers, or on-box in individual client information handling systems according to various embodiments herein. In some embodiments, it is understood any or all portions of computer-readable program code instructions (e.g., software algorithms), parameters, and profiles 118 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms), parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless I/O devices 148 described herein. In an embodiment, the information handling system 100 may be in wired or wireless communication with the wired or wireless I/O devices 148 such a keyboard 152, a mouse 158, video display device 150, stylus 154, trackpad 156, microphone 160, among other peripheral devices. Further, the information handling system may be couplable to one or more personal area network (PAN) devices 177 such as external peripheral devices operably couplable via wireless interface device, network interface device for wired couplings, or via ports in embodiments herein.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In some embodiments, adapter 134 may be a wired network interface adapter. In embodiments described herein, the wireless interface device 134 with its radio 136, RF front end 138 and antenna 140-1, 140-2 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In some embodiments, the wireless interface device 134 with its radio 136, RF front end 138 and antenna 140-1, 140-2 is used to communicate with the wireless peripheral devices located within a personal area network (PAN) via, for example, a WiFi connection, a Bluetooth® connection, a BLE connection, near-field communication, and the like. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146.

Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 132) with transmitter/receiver circuitry, modem circuitry, one or more antenna RF (RF) front end circuits 138, one or more wireless controller circuits, amplifiers, antennas 140-1, 140-2 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions (e.g., software algorithms), parameters, and profiles 118 or receives and executes computer-readable program code instructions (e.g., software algorithms), parameters, and profiles 118 responsive to a propagated signal, so that a hardware device connected to a network 142 may communicate voice, video, or data over the network 142. Further, the computer-readable program code instructions (e.g., software algorithms), parameters, and profiles 118 may be transmitted or received over the network 142 via the network interface device or wireless interface adapter 134.

The information handling system 100 may include a set of computer-readable program code instructions (e.g., software algorithms), parameters, and profiles 118 that may be executed to cause the computer system to perform any one or more of the methods or computer-based functions disclosed herein. For example, computer-readable program code instructions (e.g., software algorithms), parameters, and profiles 118 may be executed by a hardware processor 102, GPU 106, EC 104, APU 108, NPU 110 or any other hardware processing resource and may include software agents, or other aspects or components used to execute the methods and systems described herein. Various software modules comprising application computer-readable program code instructions (e.g., software algorithms), parameters, and profiles 118 may be coordinated by an OS 122, and/or via an application programming interface (API). An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include computer-readable program code instructions (e.g., software algorithms), parameters, and profiles 118 in which one or more sets of machine-readable program code instructions, parameters, and profiles 114 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of computer-readable program code instructions (e.g., software algorithms), parameters, and profiles 118 described herein. The disk drive unit 126 or static memory 114 also contain space for data storage. Further, the computer-readable program code instructions (e.g., software algorithms), parameters, and profiles 118 may embody one or more of the methods as described herein. In a particular embodiment, the computer-readable program code instructions (e.g., software algorithms), parameters, and profiles 118 may reside completely, or at least partially, within the main memory 112, the static memory 114, and/or within the disk drive 126 during execution by the hardware processor 102, EC 104, GPU 106, APU 108, or NPU 110 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a computer-readable program code instructions (e.g., software algorithms), parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110 a video/graphic display device 150, or other wired I/O devices 148 such as the mouse 158, the stylus 150, the keyboard 152, and the trackpad 156 and other components that may require power when a power button has been actuated by a user. In an embodiment, the PMU 128 may monitor power levels and be electrically coupled to the information handling system 100 to provide this power. The PMU 128 may be coupled to the bus 124 to provide or receive data or machine-readable code instructions. The PMU 128 may regulate power from a power source such as the battery 130 or AC power adapter 132. In an embodiment, the battery 130 may be charged via the AC power adapter 132 and provide power to the components of the information handling system 100, via wired connections as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool software module 162 and an AI productivity tool subagent 166 to select among a plurality of machine learning (ML) model algorithms 182, 184, 186 for use with execution of a plurality of AI productivity tool-enablable software applications 188 according to another embodiment of the present disclosure. As described herein, the AI productivity tool software module 162 and AI productivity tool subagent 166 may be executed by a hardware processor 102 on the information handling system 100 thereby allowing the methods described herein to be carried out on-the-box such that a wired or wireless network connection to a network is not necessary for operation of the method. In another embodiment, some modules, databases, and/or processing resources may be maintained on a remote server such that a wired or wireless network connection can be made with these remote servers and the method may be implemented as described herein. For example, a remote workspace environment management server 198 and workspace capabilities, device inventory and policy database 199 may be used with AI productivity tool software module 162 and PAN device preferences AI software application 194 at the information handling system 100 in embodiments herein.

The AI productivity tool software module 162 may include any artificial intelligence-based productivity tool to assist in interfacing with and execution of one or more AI productivity tool-enablable software applications 188 or inputs and responses for a user of an information handling system 100. The AI productivity tool software module 162 may be loaded on-the-box by a manufacturer in software and may include chatbot features, virtual assistant features, and other artificial intelligence features that allow a user to provide input to the information handling system 100 and, with generative artificial intelligence processing of a user input query, execute one or more capabilities that include hardware operations, functions, software services, or responses using one or more AI productivity tool-enablable software applications 188. Examples of some AI productivity tool software modules 162 may include Cortana® by Microsoft®, Copilot® by Microsoft®, Siri® by Apple® Inc., Gemini® by Google AI®, ChatGPT® by OpenAI®, and Amazon Alexa® by Amazon®, among others. It is appreciated that the information handling system 100 may include any proprietary AI productivity tool software module 162 installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity tool software module 162 with its AI productivity tool plug-in 164 and monitor for user input for a user query at a microphone 160, keyboard 152, or other input device for the AI productivity tool software module 162 to engage in capability intent actions pursuant to the user query input.

The AI productivity tool software module 162, executing on the hardware processor 102 or other hardware processing resource (e.g., EC 104, GPU 106, APU 108, or NPU 110), may interface with other hardware components and with the AI productivity tool-enablable software applications 188 and one or more ML module algorithms 182, 184, 186 the information handling system 100 via an AI productivity tool plug-in 164. The AI productivity tool plug-in 164 may be any software or firmware that allows the AI productivity tool software module 162 to perform those actions at the information handling system 100 based on user-query input (e.g., typed, spoken words, images, etc.) provided from the user. The AI productivity tool plug-in 164 may be used by the AI productivity tool software module 162 and AI productivity tool subagent 166 to interface with any number of AI productivity tool-enablable software applications 188 executing or executable on the information handling system 100 according to embodiments herein.

The information handling system 100 also includes the AI productivity tool subagent 166 of the AI productivity tool software module 162. The AI productivity tool subagent 166 may be any software and/or firmware executable by the hardware processor 102 of the information handling system 100 to interface one or more of the plurality of the AI productivity tool-enablable software applications 188 (such as a remediation (AMDS) software application, Dell® Optimizer® software application, Dell® Trusted Device® software application, Dell® Display and Peripheral Manager® software application, AWCC software application, Dell® Support Assist® software application, a virtual assistant module, etc.). Interface and managing capabilities of the plurality of the AI productivity tool-enablable software applications 188 provides AI enabled capabilities within those AI productivity tool-enablable software applications 188 for responsive hardware, firmware, or software operations, functions, software services, or responses to user-query inputs.

In an embodiment, the computer-readable program code instructions of the software applications (e.g., AI productivity tool-enablable software applications 188) and modules described herein may operate wholly “on-box” within the information handling system 100 or be sub-agents on-box for interfacing with remote software systems executing at remote server locations such as the remote workspace environment management server 198 described herein. In an embodiment, the AI productivity tool subagent 162 may be used to direct the execution of various modules in support of the AI productivity tool-enablable software applications 188 described herein. Additionally, the AI productivity tool subagent 166 may be provided with access to the BIOS 120 and OS 122 of the information handling system 100 to conduct the capability intent actions pursuant to the user's query input provided via the AI productivity tool software module 162 or with an interface of one of the AI productivity tool-enablable software applications 188.

In an embodiment, the hardware processor 102 or other hardware processing resource (e.g., EC 104, GPU 106, CPU, APU 108, or NPU 110) executing computer-readable program code instructions of the AI productivity tool subagent 166 may engage with a machine learning model requesting module 176 to have one or more ML module algorithms 182, 184, 186 loaded and executed on the hardware processor in order to, initially, determine the query intent value to correlate with a capability intent action to be conducted responsive to the received user-query inputs. In an embodiment, the execution of the computer-readable program code instructions of the AI productivity tool subagent 166 may call a software development kit (SDK) module that includes any computer-readable program code instructions that is executed by the hardware processor 102 or other hardware processing resource to request that a ML module algorithm 182, 184, 186 be invoked to support an identification of, in an embodiment, a capability intent action based on received user-query inputs from a user.

In example embodiments herein, the ML model algorithms 182, 184, 186 may include a query input-to-intent ML model algorithm 184 that receives the user-query input, and with an embedding algorithm generates a vectorized query intent value for the user-query input for later correlation with a capability intent value. In embodiments where the user-query input is in audio form, the AI productivity tool subagent 166 may invoke the execution of a speech-to-text ML model algorithm 182 to initially convert this audio into text for use with the query input-to-intent ML model algorithm 184 to generate the vectorized query intent value for the user-query input for later correlation with a capability intent value as described herein.

In an example embodiment, the ML model algorithms 182, 184, 186 may also include a query intent-to-capability matching ML model algorithm 186. The query intent-to-capability matching ML model algorithm 186 receives the vectorized query intent value from the execution of the query input-to-intent ML model algorithm 184 as input and then matches the vectorized query intent value to a vectorized capability intent value associated with the AI productivity tool-enablable software application 188 via a similarity correlation algorithm for lexical or semantic matching to identify a responsive capability that can serve as the capability intent action responsive to a user-query input. In some embodiments, the capabilities may include capabilities associated with one or more built-in AI productivity tool-enablable software applications. In embodiments of the present disclosure, the AI productivity tool-enablable software application may include the PAN device preferences AI software application 194 for determining inputs including the user query input received at the OTB AI productivity tool software module 162 requesting workspace identification and set up, as well as PAN device identification and configurations, user usage history, and security policy requirements.

It is appreciated that the selected ML module algorithms 182, 184, 186 may satisfy an interface contract requested by the AI productivity tool subagent 166 and PAN device preferences AI software application 194 such that the query intent value from the user-query inputs and PAN device identification and configurations, user usage history, and security policy requirements may be interpreted and plural available capabilities associated with one of the plurality of AI productivity tool-enablable software applications 188 as the capability intent action can be matched to the user's query input and the PAN device identification and configurations, user usage history, and security policy requirements to identify a workspace, PAN devices, and establish operative connectivity to the PAN devices in a workspace. The interface contract described herein defines the requirements that selected ML module algorithms 182, 184, 186 are to have in order to be able receive a specific type of input from the AI productivity tool subagent 166 or any PAN device detection module 181, environment device detection and policy software application, and remote workspace capabilities, device inventory and policy database 199 as well as any other executing AI productivity tool-enablable software applications 188 and to provide a specific type of output to the AI productivity tool subagent 166 and/or AI productivity tool-enablable software applications 188 for selecting a workspace 177 and establishing operable connectivity to and configuration with PAN devices 179 therein. In an embodiment, the interface contract is generated by an AI productivity proxy API invoked by the SDK module in order to identify the specific ML module algorithms 182, 184, 186 that provide the appropriate output to the AI productivity tool subagent 166. The execution of the computer-readable program code of the AI productivity tool subagent 166 allows a user to interface with the AI productivity tool software module 166 (e.g., via text, audio, images, etc.) and have a responsive action, such as a hardware operation or adjustment, software service, or other response from the information handling system 100, including selecting a workspace 177 and establishing operable connectivity to and configuration with PAN devices 179, that satisfies the user's query input.

As described herein, the hardware processor 102 or other hardware processing device may execute computer-readable program code instructions of an environment device detection and policy software application 196. Execution of the environment device detection and policy software application 196 requests and receives location data describing a current location of the information handling system 100 and an identification of personal area network (PAN) devices available for use by the information handling system 100. In an embodiment, the current location of the information handling system 100 may be obtained via execution of computer-readable program code instructions 118 of a location detection software application 192. The location detection software application 192 may access certain data in order to discover and determine the location of the information handling system 100 including, for example, network positioning data in a Wi-Fi or LTE network, global positioning (GPS), or other location identifying techniques. In an example embodiment, the location detection software application 192 may access a remote workspace environment management server 198 via the wireless interface adapter 134 and a first antenna 140-1 accessing a wireless network 142 and provide a determined location of the information handling system, such as a device identifier within a Wi-Fi basic service set identifier (BSSID) for an access point 144 at a network location or network identifier of information handling system 100 relative to an internet protocol address relative to a base station 146, or any other location indication. In an embodiment, the remote workspace environment management server 198 may manage identified workspace device inventories within any of a plurality of workspaces, capabilities associated with devices at those workspaces, and communication policies associated with each of those devices within any of those given workspaces.

In some embodiments, a specific physical arrangement of peripheral devices, referred to as the PAN devices 179, within the workspace 177 may be provided that can direct the user (e.g.,, via a visual notification at the video/graphics display device 150) to a specific location within the workspace 177 that would best fit the user's needs with regard to optimizing the operation of the information handling system 100 upon determination of PAN devices 179 to operatively couple by execution of the PAN device preferences AI software application 194. In an embodiment, the remote workspace environment management server 198 may maintain a workspace capabilities device inventory and policy database 199. The workspace capabilities device inventory and policy database 199 identifies, by workspace identification (ID), any number of workspaces 177, their respective PAN devices 179 located within those workspaces 177, and those communication policies associated with each of those PAN devices 179. In an example embodiment, the workspace capabilities device inventory and policy database 199 may include a hoteling workspace identified by a unique workspace ID. This hoteling workspace may be registered with the remote workspace environment management server 198 for purposes of any location detection software application 192 executing on any information handling system 100 to access data about the hoteling workspace (e.g., 177). The identified hoteling workspace may include a description of the number, arrangement, and communication policies associated with those PAN devices 179 within the hoteling workspace (e.g., 177).

In an embodiment, the location detection software application 192 may access a PAN device detection module 181. The PAN device detection module 181 may access the wireless interface adapter 134 to detect any number of wireless PAN devices 179 within any workspace 177 that the information handling system 100 is close to or within communication range. It is appreciated that this may include communicating with each of the PAN devices 179 using an in-band communication protocol or an out-of-band communication protocol in various embodiments. For example, BLE® may be used for in-band discovery communications and that protocol that may later be used to operatively couple to those PAN devices 179. In another example, a WLAN or other network may be used to discover PAN devices 179 out of band but may not be used to operatively couple to the information handling system 100 in other embodiments. In an embodiment, this communication with each PAN device 179 may be accomplished by the PAN device detection module 181 directing the wireless interface adapter 134, or even a wired network interface in some cases, to detect wireless broadcasting signals or wired signals broadcasting from each of the wireless PAN devices 179 within the workspace 177. After the PAN device detection module 181 has received data related to any PAN device 179 within the workspace 177, this data may be transmitted to the environment device detection and policy software application 196 for use with the PAN devices preferences AI software application 194 as described in embodiments herein. It is appreciated that, in some embodiments, the location detection software application 192 may access data from both the remote workspace environment management server 198 and the wireless interface adapter 134 to gain the most recent and accurate data indicating the availability of the PAN devices 179 within a workspace 177 that the information handling system 100 has been moved into.

As described herein the PAN devices 179 may be any device, such as peripheral devices, within a detected workspace 177 that may be operatively coupled to the user's information handling system. In a context of a hoteling workspace, these PAN devices 179 may include a first printer located in a central location within the workspace 177, a second printer located within a relatively more private location within the workspace 177, a plurality of cubicles each with a wired or wireless external monitor 150 and wired or wireless keyboard 152, as well as other peripheral devices that may facilitate a user entering the hoteling workspace.

In an embodiment, a hardware processor (e.g., 102, 104, 106, 108, 110) of the information handling system 100 may also execute computer-readable program code instructions 118 of a historic usage software application 190. The historic usage software application 190 may track and define historic information handling system usage patterns describing how the user has historically used the information handling system 100. This may include identification of execution of types of any software applications such as a presentation software application (e.g., Microsoft® PowerPoint®), times or context of execution of those software applications, use of wired or wireless peripheral devices with the information handling system 100 in any of a plurality of identified workspaces, historic printer usage, duration of execution of the various software applications, among other historic usage patterns of the information handling system 100. In an embodiment, the historic information handling system usage patterns may be periodically or continuously updated via the historic usage software application 290 tracking ongoing usages by the user in anticipation of that historic information handling system usage patterns data being used in the methods described herein. This historic information handling system usage patterns may be used by the PAN device preferences AI software application 194 of the AI productivity tool subagent 166 to determine which of the PAN devices 179 within a new or previously-used workspace 177 should be operatively coupled to the information handling system 100 as the user transports the information handling system 100 within the physical area of the workspace 177 in embodiments. Further, this historic information handling system usage patterns may be used by the PAN device preferences AI software application 194 of the AI productivity tool subagent 166 to determine how the PAN devices 179 within a new or previously-used workspace 177 should be configured in other embodiments.

During operation, the user may wish to connect to one or more of the PAN device 179 as the user brings the information handling system 100 into a new workspace 177 such as the hoteling workspace in the example embodiment presented herein. The user may interface with the AI productivity tool software module 162 and provide user-query input such as “direct me to a workspace so I can review my presentation.” This user-query input received at the AI productivity tool software module 162 is transmitted to the AI productivity tool subagent 166 via the AI productivity tool software plug-in 164. Once the user-query input is received by the AI productivity tool subagent 166, the hardware processor 102 or other hardware processing device may execute the machine learning algorithms 182, 184 and 186 to determine that a capability for the PAN device preferences AI software application 194 should be executed to assist in determining the workspace 177 or PAN devices 179 for operative coupling. Execution of the computer-readable program code instructions 118 of the PAN device preferences AI software application 194 proceeds to receive the user query input as well as the location data, PAN devices identifications, and the historic information handling system usage patterns as inputs.

As described herein, the PAN device preferences AI software application 194 executes to determine which further capabilities are to be executed by one or more AI productivity tool-enablable software applications 188 pursuant to the user-query input of, in this example embodiment, “direct me to a workspace so I can review my presentation” and inputs of the location data, PAN devices identifications, and the historic information handling system usage patterns. For example, the location data as detected by the location detection software application 192, the historic information handling system usage patterns determined by the historic usage software application 190, and available PAN devices as detected by the PAN device detection module 181 may be used as part of the input, along with the user-query input, to the one or more ML model algorithms 182, 184, 186 within the machine-learning model algorithm database 180 to identify one or more responsive capabilities associated with one or more AI productivity tool-enablable software applications 188.

These responsive capabilities associated with one or more AI productivity tool-enablable software applications 188 may include generating a response message to a user identifying or showing the user which PAN devices 179 to connect with in an embodiment. These responsive capabilities associated with one or more AI productivity tool-enablable software applications 188 may include determining required trust relationships, such as passwords or exchanged authorizations, needed to operatively couple with one or more of the PAN devices 179 in an embodiment. These responsive capabilities associated with one or more AI productivity tool-enablable software applications 188 may include determining pre-pairing for operative coupling with one or more of the PAN devices 179 in an embodiment. These responsive capabilities associated with one or more AI productivity tool-enablable software applications 188 may include pre-configuring the one or more of the PAN devices 179 or the information handling system 100 in advance of operative coupling in an embodiment. These responsive capabilities associated with one or more AI productivity tool-enablable software applications 188 may include determining and implementing ITDM or enterprise policies ova any sort in advance of operative coupling with one or more of the PAN devices 179 in an embodiment.

For example, as the user walks into the hoteling workspace, the identified printers (located at a communal location and a relatively more private area) and other PAN devices 179 are detected and that information is provided to the PAN device preferences AI software application 194. Concurrently, the execution of the environment device detection and policy software application 196 detects communication policies associated with those PAN devices 179 within the workspace 177 in an embodiment. These PAN device communication polices may establish security requirements needed to pre-pair with the PAN devices 179 identified, but must also align with security policy applicable to the information handling system 100, the user's security level, the tasks executed by the user, the location, and the PAN devices in embodiments herein. For example, the environment device detection and policy software application 196 may access, via wireless interface device 134 or network interface device, the remote workspace environment management server 198 and a workspace capabilities, device inventory, and policy database administered by an enterprise. This data is used as input along with the user-query input into the PAN device preferences AI software application 194 and the AI productivity tool subagent 166. Execution of the PAN device preferences AI software application 194 in the AI productivity tool subagent 166 operates to identify, for example, a capability intent action of a wireless connection capability associated with the Dell® Trusted Device® software application that can be used to wirelessly couple the one or more PAN devices 179 to the information handling system 100. Additionally, another capability intent action may be of a Dell® Display and Peripheral Manager® software application to identify or match one of the plurality of detected PAN devices 179 that can be used to mimic the user's historic use of the information handling system 100. For example, where the historic information handling system usage patterns indicate that the user has favored the use of one or more external video/graphics display devices 150 in addition to the built-in video-graphics display device 150, the capability intent actions identified by the PAN device preferences AI software application 194 in the AI productivity tool subagent 166 may invoke the Dell® Display and Peripheral Manager® software application. Capability actions of the Dell® Display and Peripheral Manager® software application include indicating that a wireless external video/graphics display device is available and that the Dell® Trusted Device® software application should initiate communication with the external video/graphics display device to better conform to the historic information handling system usage patterns.

In another embodiment, other responsive capabilities may be identified by the PAN device preferences AI software application 194 in the AI productivity tool subagent 166 that are associated with the environment device detection and policy software application 196 includes identifying communication policies, such as required trust relationships, associated with any of these PAN devices 179 within the workspace 177 (e.g., a relatively more private printing device and the identified external video/graphics display device) and establishing communication between those PAN devices 179 and the information handling system 100 using appropriate and secure methods. Indeed, execution of capabilities of the environment device detection and policy software application 196 may dictate the terms, conditions, and policies under which communication is established between the PAN devices 179 and the information handling system 100. For example, the PAN device communication polices may establish security requirements needed to pre-pair with the PAN devices 179 identified, but must also require alignment with security policy applicable to the information handling system 100, the user's security level, the tasks executed by the user, the location, and the PAN devices in embodiments herein. This may include imposing stricter and expansive security protocols. Without the necessary security protocols being met, the environment device detection and policy software application 196 may prevent the operative coupling of the information handling system 100 to one or more PAN devices 179. In an embodiment where the communication policies associated with the PAN devices 179 are not sufficient to secure proper security operations, the environment device detection and policy software application 196 provides expanded security policies used to dynamically adjust security protocols to be used to operatively couple the PAN devices 196 to the information handling system 100 such as requiring Wi-Fi protected access 2 (WPA2) and WPA3 protocols that require shared encryption keys and handshake mechanisms that prevent offline passkey attacks. In an embodiment, the hardware processor 102 may execute computer-readable program code instructions 118 of an environment device detection and policy software application 196 to receive predictive pairing credentials associated with each of the PAN devices 179 for use in pre-pairing the PAN devices 179 prior to establishing the trust relationship between the information handling system 100 and one or more of the identified PAN devices 179. This two-step process may, in an example embodiment, be sufficient to satisfy the communication policy requirements to be used between the PAN devices 179 and the information handling system 100.

The described systems and methods herein provide for execution of computer readable code instructions of the PAN device preferences AI software application 194 in the AI productivity tool subagent 166 for identification of workspaces 177 and automated operatively coupling of one or more PAN devices 179 within a workspace 177 that best accommodates the user's use of the information handling system in embodiments. In further embodiments, the execution of the PAN device preferences AI software application 194 in the AI productivity tool subagent 166 also provides for securely coupling those PAN devices 179 to the information handling system 100. Still further, this process may be conducted with little or no input from the user besides an initial user-query input (e.g., “direct me to a workspace so I can review my presentation”). Having been presented with the best possible working environment within the workspace, productivity may be increased.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

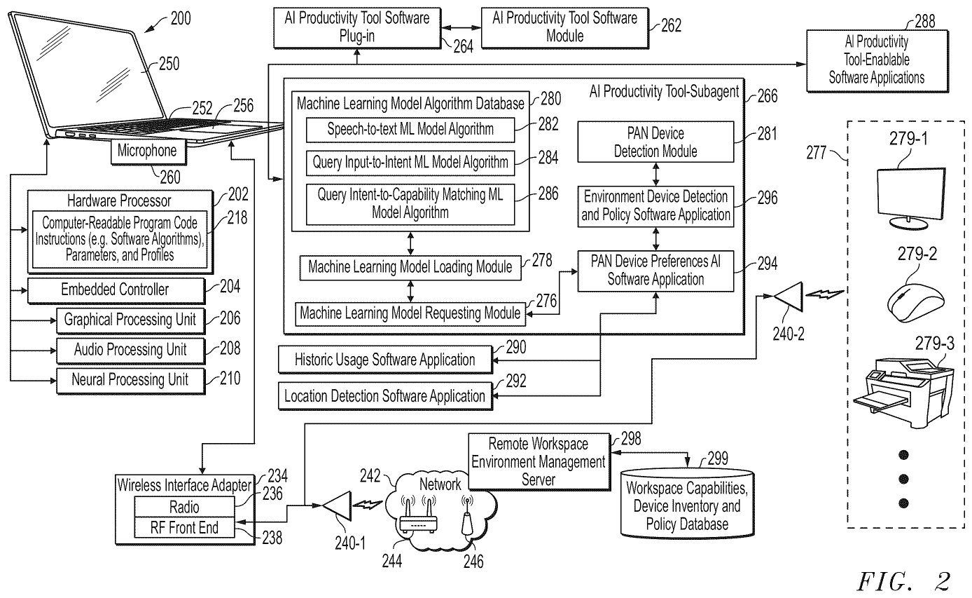

FIG. 2 is a graphic and block diagram illustrating an information handling system 200 that includes computer-readable program code instructions of an AI productivity tool software application 262 and a PAN device preferences AI software application 294 to select among a plurality of AI productivity tool-enablable software applications 288 for software services, operations, or responses of those AI productivity tool-enablable software applications 288 according to embodiments herein. In particular, information handling system 200 executes computer-readable program code instructions of the AI productivity tool software application 262 and the PAN device preferences AI software application 294 to select among a plurality of capabilities of AI productivity tool-enablable software applications 288 to identify a workspace 277, identify one or more PAN devices 279-1, 279-2, 279-3 or others in the workspace 277, and configure and operatively couple a selection of the PAN devices 279-1, 279-2, 279-3 or others in the workspace 277 in embodiments herein. This selection of a workspace 277 and PAN devices 279-1, 279-2, 279-3 or others in the workspace 277 for operative coupling and configuration may be controlled under one or more capability intent action policies including establishing a logical trust relationship with one or more PAN devices 279-1, 279-2, 279-3 within a detected workspace 277 according to an embodiment of the present disclosure.

As described herein, the information handling system 200 in FIG. 2 is shown as a laptop-type information handling system 200. The information handling system 200 may include a video display device 250 to provide output to the user as well as a keyboard 252, a touchpad 256, and microphone 260 for the user to provide input to the information handling system 200. This laptop-type information handling system 200 may be readily portable from a first workspace such as a home office to a second workspace such as a hoteling workspace. It is appreciated that regardless of the type of workspace 277 where the laptop-type information handling system 200 is physically brought to, execution of the PAN device preferences AI software application 294 with the AI productivity tool software module 262 of the present systems and methods may be used to recognize the location of the workspace 277 and identify those PAN devices 279 available to be operatively coupled with the information handling system 200 that would best fit with the user's historic information handling system usage patterns.

In an example embodiment, the workspace 277 may include a conference room where a user is to give a presentation by executing, for example, Microsoft® Powerpoint® or any other presentation software application. As described herein, the workspace 277 may include a plurality of PAN devices 279-1, 279-2, 279-3. In FIG. 2 example PAN devices 279-1, 279-2, 279-3 include a printer 279-3, a wireless mouse 279-2, and an external video/graphics display device 279-1.

During operation, the user may wish to connect to one or more of the PAN devices 279-1, 279-2, 279-3 as the user brings the information handling system 200 into the workspace 277 such as the conference room workspace in the example embodiment presented herein. The user may interface with the AI productivity tool software module 262 and provide user-query input such as “set me up to conduct my presentation” via the microphone 260. It is appreciated, and the present specification contemplates that other types of input such as text, video, and/or image input may be received and used as this user-query input. This user-query input received at the AI productivity tool software module 262 is transmitted to the AI productivity tool subagent 266 via the AI productivity tool software plug-in 264 for processing using one or more ML model algorithms 282, 284, 286. For example, the execution of a speech-to-text ML model algorithm 282 converts this audio into text for use with the query input-to-intent ML model algorithm 284 to generate the vectorized query intent value for the user-query input for later correlation with a capability intent value as described herein.

The query intent-to-capability matching ML model algorithm 286 may receive this vectorized query intent value from the execution of the query input-to-intent ML model algorithm 284 as input and then match the vectorized query intent value to a vectorized capability intent value associated with the AI productivity tool-enablable software application 288 via a similarity correlation algorithm for lexical or semantic matching to identify a responsive capability that can serve as the capability intent action responsive to a user-query input. That responsive capability may include further execution with the PAN device preferences AI software application 294 to select a workspace 277 and select, operably couple to and configure any of a plurality of PAN devices 279-1, 279-2, 279-3. In embodiments of the present disclosure, further execution of the one or more ML model algorithms 282, 284, 286 by the PAN device preferences AI software application 294 with additional inputs from modules, as described herein, identify further capabilities for execution associated with a plurality of built-in AI productivity tool-enablable software applications 288 for identifying, selecting, operably coupling, or configuring PAN devices 279-1, 279-2, 279-3 in a workspace 277 according to embodiments herein. In the example embodiment presented in FIG. 2, at least one of these capabilities may include starting up the presentation software application and opening up a presentation file most recently modified or accessed by the user in anticipation for the user to present the subject matter of that file to a group of individuals meeting within the conference room.

Prior to or concurrently with the user-query input being received by the AI productivity tool subagent 266, the hardware processor 202 or other hardware processing device (e.g., 204, 206, 208, 210) may execute the computer-readable program code instructions of the PAN device preferences AI software application 294 in the AI productivity tool subagent 266 to receive the location data, identified PAN devices 279-1, 279-2, 279-3, user query input, and the historic information handling system usage patterns. As described herein, this data is used to influence selection of responsive capabilities that are to be executed by one or more AI productivity tool-enablable software applications 288 pursuant to the user-query input of, in this example embodiment, “set me up to conduct my presentation.”

As described herein, the location detection software application 292 may access certain data in order to discover and determine the location of the information handling system 200. Location data may be determined from a variety of location techniques including use of a client network identification of the information handling system 200 and relative wireless interface adapter 234 location within a WLAN or WWAN network (e.g., relative to one or more APs 244 or base stations 246) in an embodiment. Other location information data may be used as well, such as from GPS systems, sensors within enterprise facilities, wired connectivity to wired network locations, or others in various embodiments. In an example embodiment, the location detection software application 292 transmits location information to and accesses a remote workspace environment management server 298 via the wireless interface adapter 234 and a first antenna 240-1 accessing a wireless network 242. In an embodiment, the communications with the remote workspace environment management server 298 via the wireless interface adapter 234 and a first antenna 240-1 accessing a wireless network 242 may be used to identify location of the information handling system 200. In an embodiment, the remote workspace environment management server 298 may manage identified workspaces 277 at various managed locations in an enterprise as well as PAN device inventories within any of a plurality of workspaces 277 in the enterprise. The remote workspace environment management server 298 may monitor and manage capabilities and configurations associated with those PAN devices 279-1, 279-2, 279-3, and communication policies associated with each of those devices within any of those given workspaces.

In some embodiments, a specific physical arrangement of the PAN devices 279-1, 279-2, 279-3 within the conference room workspace 277 may be provided that can direct the user (e.g.,, with a visual notification at the video/graphics display device 250) to a specific location within the workspace 277. Such specific arrangement data of the PAN devices 279-1, 279-2, 279-3 within the conference room workspace 277 may be used with the PAN device preferences AI software application 294 in the AI productivity tool subagent 266 for determining and recommending the best fit of the user's needs with regard to optimizing the operation of the information handling system 200. In an embodiment, the remote workspace environment management server 298 may maintain a workspace capabilities device inventory and policy database 299 that identifies, by workspace identification (ID), any number of workspaces 277, their respective PAN devices 279-1, 279-2, 279-3 located within those workspaces 277, and those communication policies associated with each of those devices. In an example embodiment, the workspace capabilities device inventory and policy database 299 may include the conference room workspace 277 in FIG. 2 identified by a unique workspace ID. This hoteling workspace 277 may be registered with the remote workspace environment management server 298 for purposes of any location detection software application 292 executing on any information handling system 200 to access data about the conference room workspace 277. The identified conference room workspace 277 may include a description of the number, arrangement, and communication policies associated with those PAN devices 279-1, 279-2, 279-3 within the conference room workspace 277.

In an embodiment, the location detection software application 292 may access a PAN device detection module 281. The PAN device detection module 281 may access the wireless interface adapter 234 to detect any number of wireless PAN devices 279-1, 279-2, 279-3 within, in an example embodiment, the conference room workspace 277 that the information handling system 200 is close to or within communication range. It is appreciated that this may include communicating with each of the PAN devices 279-1, 279-2, 279-3 using an in-band communication protocol or an out-of-band communication protocol. In an embodiment, this communication with each PAN devices 279-1, 279-2, 279-3 may be accomplished by the PAN device detection module 281 directing the wireless interface adapter 234 to detect wireless broadcasting signals broadcasting from each of the wireless PAN devices 279-1, 279-2, 279-3 within the conference room workspace 277 or to broadcast a wireless signal to the wireless PAN devices 279-1, 279-2, 279-3. The broadcast signal may be in a wireless protocol that is in-band and in the same wireless protocol that may be used for communication, such as in BLE® or may be in an out of band different wireless protocol, such as Wi-Fi when BLE® will be used for operative coupling or vice-versa. Additionally, the PAN device detection module 281 may communicate externally to or through the remote workspace environment management server 298 in some embodiments to detect the wireless PAN devices 279-1, 279-2, 279-3 at a given workspace 277.

After the PAN device detection module 281 has received data related to any PAN device 279-1, 279-2, 279-3 within the conference room workspace 277 from direct in-band or out of band communications with PAN devices 279-1, 279-2, 279-3, this data may be transmitted to the environment device detection and policy software application 296 for use as described herein. It is appreciated that, in some embodiments, the location detection software application 292 may access data from both the remote workspace environment management server 298 and the wireless interface adapter 234 to gain the most recent and accurate data indicating the availability of the PAN devices 279 within the conference room workspace 277 and correlation of relative location in the workspace 277 that the information handling system 200 has been moved into.

As described herein, the PAN devices 279-1, 279-2, 279-3 may be any device within a detected conference room workspace 277 that may be operatively coupled to the user's information handling system 200. In the context of this conference room workspace 277, these PAN devices 279-1, 279-2, 279-3 may include a printer 279-3, the wireless mouse 279-2, and the external video/graphics display device 279-1 as well as other peripheral devices that may facilitate a user's activity upon entering the conference room workspace 277. Execution of the systems and methods of the PAN device preferences AI software application 294 in the AI productivity tool subagent 266 described herein may allow for the operatively coupling of all, some, or none of these PAN devices 279-1, 279-2, 279-3 depending on the detected security protocols associated with each of the PAN devices 279-1, 279-2, 279-3 as well as the historic information handling system usage patterns described herein to satisfy the user query input.

Concurrently, the execution of the environment device detection and policy software application 296 detects communication policies associated with those PAN devices 279-1, 279-2, 279-3 within the conference room workspace 277. For example, these PAN device communication polices may establish security requirements needed to pre-pair with the identified PAN devices 279-1, 279-2, 279-3, but must also align with security policy applicable to the information handling system 100, the user's security level, the tasks executed by the user, the location, and the PAN devices 279-1, 279-2, 279-3 selected in embodiments herein. This data is used as input to the PAN device preferences AI software application 294 along with the user-query input to identify, for example, a wireless connection capability associated with the Dell® Trusted Device® software application that can be used to wirelessly couple the one or more PAN devices 279-1, 279-2, 279-3 to the information handling system 200. Additionally, other responsive capabilities of a Dell® Display and Peripheral Manager® software application may identify one of the plurality of detected PAN devices 279-1, 279-2, 279-3 that can be used to mimic the user's historic use of the information handling system 200 by execution of the PAN device preferences AI software application 294. For example, where the historic information handling system usage patterns indicate that the user has favored the use of one or more external video/graphics display devices in addition to the built-in video-graphics display device 250, execution of the PAN device preferences AI software application 294 in the AI productivity tool subagent 266 may identify responsive capabilities of the Dell® Display and Peripheral Manager® software application to identify and indicate that a wireless external video/graphics display device is available and the Dell® Trusted Device® software application should initiate communication to configure the external video/graphics display device 279-1 to better conform to the historic information handling system usage patterns. Additionally, because the user-query input of “set me up to conduct my presentation” indicates that the user is going to presenting the presentation, a responsive capability may need to be executed to establish operative coupling and configure the PAN device 279-1 via the Dell® Trusted Device® software application and Dell® Display manager applications regardless of the user's past usage history of the information handling system 200.

Still further, a responsive capability may be identified by execution of the PAN device preferences AI software application 294 in the AI productivity tool subagent 266 that is associated with the environment device detection and policy software application 296 that identifies communication policies associated with any of these PAN devices 279-1, 279-2, 279-3 within the conference room workspace 277. As described, these PAN device communication policies may establish security requirements needed to pre-pair with the PAN devices 279-1, 279-2, 279-3 identified in embodiments herein. Further, the PAN device communication policies also require that the operative coupling and security measures used to operatively couple to the PAN devices 279-1, 279-2, or 279-3 must also align with the security policy applicable to the information handling system 100, the user's security level, the tasks executed by the user, the location, and the PAN devices in embodiments herein. Then further responsive capabilities to the user query input include establishing communication between those PAN devices 279-1, 279-2, 279-3 and the information handling system 200 using appropriate and secure methods.

Indeed, execution of the environment device detection and policy software application 296 may dictate the terms, conditions, and policies under which communication is established between the PAN devices 279-1, 279-2, 279-3 and the information handling system 200 by execution of responsive capabilities identified by execution of the PAN device preferences AI software application 294 in the AI productivity tool subagent 266. This may include imposing stricter and expansive security protocols or may include a determination that because the conference room workspace 277 is within a trusted enterprise (e.g., a work conference room), the communication security policies may be reduced because those PAN devices 279-1, 279-2, 279-3 are deemed to be default trusted devices.

In an embodiment, without the necessary security protocols being met, the environment device detection and policy software application 296 may prevent the operative coupling of the information handling system 200 to one or more of the PAN devices 279-1, 279-2, 279-3 in responsive capabilities identified by the execution of the PAN device preferences AI software application 294 in the AI productivity tool subagent 266. For example, where the conference room workspace 277 is new to the information handling system 200 or otherwise not part of a trusted enterprise-operated workspace, a logical trust relationship within security policy requirements may need to be established first. In an embodiment where the communication policies associated with the PAN devices 279-1, 279-2, 279-3 are not sufficient to secure proper security operations, the environment device detection and policy software application 296 may determine that a responsive capability may provide expanded security policies used to dynamically adjust security protocols to be used to operatively couple the PAN devices 279-1, 279-2, 279-3 to the information handling system 200. For example, expanded security policies may include requiring Wi-Fi protected access 2 (WPA2) and WPA3 protocols that require shared encryption keys and handshake mechanisms that prevent offline passkey attacks and responsive capability may be established for the user to initiate or execute this expanded security polity set up.

In a further embodiment, the hardware processor 202 may execute computer-readable code instructions of the PAN device preferences AI software application 294 in the AI productivity tool subagent 266 to identify the PAN devices 279-1, 279-2, 279-3 in a workspace 277 and further execute capabilities for establishing operative coupling with those PAN device 279-1, 279-2, 279-3. Pre-pairing to those PAN device 279-1, 279-2, 279-3 may be part responsive capabilities for establishing this operative coupling in an embodiment. The hardware processor 202 may execute computer-readable program code instructions 218 of an environment device detection and policy software application 296 to receive predictive pairing credentials associated with each of the PAN devices 279-1, 279-2, 279-3 for use in pre-pairing the PAN devices 279-1, 279-2, 279-3 prior to establishing the trust relationship between the information handling system 200 and one or more of the identified PAN devices 279-1, 279-2, 279-3 as a responsive capability to the user query input. This two-step process may, in an example embodiment, be responsive capabilities to the user query input identified by the PAN device preferences AI software application 294 in the AI productivity tool subagent 266 and sufficient to satisfy the communication policy requirements to be used between the PAN devices 279-1, 279-2, 279-3 and the information handling system 200.

It is appreciated that this historic information handling system usage patterns, the user-query input, the location data, the historic information handling system usage patterns, and available PAN devices may be accumulated as input to the PAN device preferences AI software application 294 for execution of the one or more ML model algorithms 282, 284, 286. For example, the PAN device preferences AI software application 294 in the AI productivity tool subagent 266 may take this input and execute a machine learning model requesting module 276 and machine learning model loading module 278 to execute one or more of the ML model algorithms 282, 284, 286. After execution of the one or more ML model algorithms 282, 284, 286, one or more responsive capabilities associated with one or more AI productivity tool-enablable software applications 288 may be identified for identification of, operative coupling with, and configuration of PAN device 279-1, 279-2, 279-3 in a workspace 277. In the context of the example embodiment described in FIG. 2, these capabilities may include wireless connection capability associated with the Dell® Trusted Device® software application that can be used to wirelessly couple the one or more PAN devices 279-1, 279-2, 279-3 to the information handling system 200. As described herein, these responsive capabilities may include the Dell® Trusted Device® software application determining current security protocols used by the PAN devices 279-1, 279-2, 279-3 and executing appropriate levels of security communication protocols that would establish a trust relationship between the information handling system 200 and one or more of the identified PAN devices 279-1, 279-2, 279-3.

In the context of the user moving the information handling system 200 into the conference room workspace 277, execution of the PAN device preferences AI software application 294 in the AI productivity tool subagent 266 may invoke a responsive capability of the Dell® Display and Peripheral Manager® software application to identify one of the plurality of detected PAN devices 279-1, 279-2, 279-3 that can be used to mimic the user's historic use of the information handling system 200. For example, where the historic information handling system usage patterns indicate that the user has not favored the use of a printer, execution of capabilities of the Dell® Display and Peripheral Manager® software application may include a capability to indicate that the printer 279-3 is available, but that the Dell® Trusted Device® software application should not initiate communication with the printer 279-3. This may be because the user, in the past, has not needed the use of a printer to make “hard copies” of the presentation. In an alternative embodiment, it may be indicated by user historical usage patterns that the user has yet to make hard copies of the presentation and, as such, may need to have the printer 279-3 print off a plurality of hard copies for those attending the meeting and engaging in the presentation from the user.

In yet another example embodiment, responsive capabilities of the Dell® Display and Peripheral Manager® software application may receive the data indicating that the wireless mouse 279-2 is made available. In instances where the user has also carried the user's personal wireless mouse into the conference room workspace 277 along with the information handling system 200, and that personal mouse is operatively coupled with the information handling system 200, this historic information handling system usage pattern may indicate that there is no need for an additional wireless mouse 279-2 and may direct that the Dell® Trusted Device® software application not establish wireless communication with the wireless mouse 279-2. Alternatively, the responsive capability may include the Dell® Trusted Device® software application establishing wireless communication with the wireless mouse 279-2 when the opposite is true and the Dell® Display and Peripheral Manager® software application does not detect that the user's personal wireless mouse is operatively coupled with the information handling system 200.

Again, the described systems and methods herein provide for execution of the PAN device preferences AI software application 294 in the AI productivity tool subagent 266 to execute a plurality of responsive capabilities to a user query input while including additional inputs above including location of the information handling system 200, identification of PAN devices in a workspace, configuration data of the PAN devices and the information handling system 200, user historical usage data, and security or other communication polices in various embodiments. Thus, execution of the execution of the PAN device preferences AI software application 294 in the AI productivity tool subagent 266 may invoke the automated operatively coupling of one or more PAN devices 279-1, 279-2, 279-3 within the conference room workspace 277 that best accommodates the user's use of the information handling system 200 while also securely coupling those PAN devices 279-1, 279-2, 279-3 to the information handling system 200. Still further, this process may be conducted with little or no input from the user besides the initial user-query input (e.g., “set me up to conduct my presentation”) such that the user may focus more on other tasks such as preparing for the presentation. Having been presented with the best possible working environment within the conference room workspace 277, productivity may be increased.

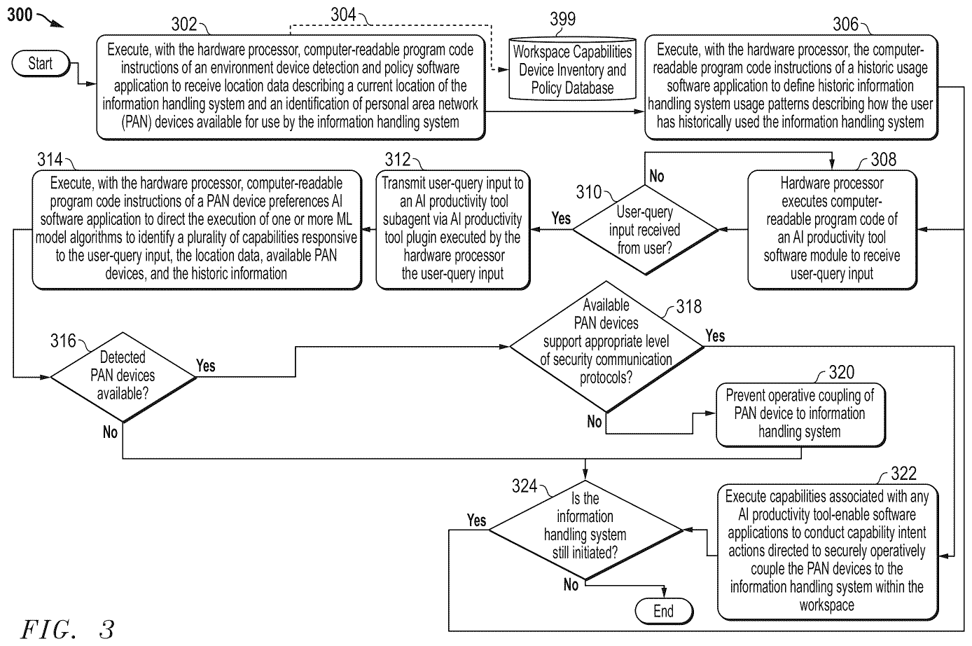

FIG. 3 is a flow diagram showing a method 300 of a method executing computer-readable program code instructions of an AI productivity tool and a PAN device preferences AI software application identify responsive capabilities for operative coupling with one or more PAN connected devices identified in a workspace for the information handling system in response to a user query input according to an embodiment of the present disclosure. The method 300 described in connection with FIG. 3 may be operated on an information handling system such as an information handling system (e.g., 100, 200) described in connection with FIG. 1 or 2. In an embodiment, the information handling system may be one of a plurality of information handling systems within an enterprise.

The method 300 may include, at block 302, executing computer-readable program code instructions of an environment device detection and policy software application to receive location data describing a current location of the information handling system and an identification of PAN devices at a workspace or workspaces at or near that location available for use by the information handling system. As described in embodiments herein, the current location of the information handling system may be obtained via execution of computer-readable program code instructions of a location detection software application. The location detection software application may access certain location data in order to discover and determine the location of the information handling system according to various embodiments herein, including via proximity to a network location such as an AP or base station, via GPS, or other location identification method.

In an example embodiment, the location detection software application may access a remote workspace environment management server via the wireless interface adapter and an antenna accessing a wireless network at line 304. In an embodiment, the remote workspace environment management server may manage identified workspace PAN device inventories within any of a plurality of enterprise-managed workspaces, capabilities associated with those PAN devices, and communication policies associated with each of those PAN devices within any of those given workspaces. In some embodiments, a specific physical arrangement of the PAN devices within the workspace may be provided that can direct the user (e.g., via a visual notification at the video/graphics display device) to a specific location within the workspace upon executing a responsive capability, if applicable, for identification of PAN devices that best fit the user's needs with regard to the operation of the information handling system in response to a user query input. In an embodiment, the remote workspace environment management server may maintain a workspace capabilities device inventory and policy database 399 that identifies, by workspace identification (ID), any number of workspaces, their respective devices located within those workspaces, and those communication policies associated with each of those devices. In an example embodiment, the workspace capabilities device inventory and policy database 399 may include a workspace identified by a unique workspace ID. This workspace may be registered with the remote workspace environment management server for purposes of any location detection software application executing on any information handling system to access data about the workspace. The identified workspace may include a description of the number, arrangement, and communication policies associated with those PAN devices within the workspace.

Additionally, or alternatively, the environment device detection and policy software application may cause the hardware processor to execute computer-readable program code instructions of a location detection software application. The location detection software application may access a PAN device detection module to, via a wireless interface device detect any number of wireless PAN devices within any workspace that the information handling system is close to or within communication range. It is appreciated that this may include communicating with each of the PAN devices using an in-band communication protocol or an out-of-band communication protocol. In an embodiment, this communication with each PAN device may be accomplished by the PAN device detection module directing the wireless interface adapter to detect wireless broadcasting signals broadcasting from each of the wireless PAN devices within the workspace or broadcast to the PAN devices in a workspace.

At block 306, the method 300 includes executing, with the hardware processor, computer-readable program code instructions of a historic usage software application to identify and define historic information handling system usage patterns describing how the user has historically used the information handling system. The historic usage software application may define historic information handling system usage patterns describing how the user has historically used the information handling system. These historic information handling system usage patterns may include execution of any software applications such as a presentation software application (e.g., Microsoft® Powerpoint®), use of wired or wireless peripheral devices with the information handling system in any of a plurality of identified workspaces, historic printer usage, duration of execution of the various software applications, among other historic usage patterns of the information handling system. In an embodiment, the historic information handling system usage patterns may be tracked and logged during usage of the information handling system to include location, workspace identifications, as well as software applications executing and wired or wireless device usage by execution of the historic usage software application in a tracking log in memory. In an embodiment, the historic information handling system usage patterns may be periodically or continuously updated via the historic usage software application in anticipation of that historic information handling system usage patterns data being used in the methods described herein. As described herein, this historic information handling system usage patterns may be used by the AI productivity tool subagent to determine which of the PAN devices within a new or previously-used workspace should be operatively coupled to the information handling system as the user transports the information handling system within the physical area of the workspace.

The method 300 may include, at block 308, the hardware processor or other hardware processing device of the information handling system executing computer-readable program code instructions of an AI productivity tool software module with the PAN device preferences AI software application to receive user-query input. In an embodiment, AI productivity tool software module may be any application that can receive input from a user such as text input via the keyboard, image or touch input via a touchpad, or speech input via the microphone, for example. In some embodiments, text or audio may be received by an interface of the one or more AI productivity tool-enablable software modules and the interface managed by the AI productivity tool sub-agent. In an embodiment, the AI productivity tool software module may include a virtual assistant-type AI software agent. In various embodiments, the hardware processor or other alternative hardware processing resources of the information handling system may execute computer-readable program code instructions of the AI productivity tool software module with its AI productivity tool software plug-in and monitor for user-query inputs at a microphone, keyboard, or other input device for the AI productivity tool subagent to engage in capability intent actions responsive to the user-query inputs.

Therefore, at block 310, the method 300 includes determining whether any user-query input has been received at the AI productivity tool software module. Where, at block 310, no user-query input is received, the method 300 returns to block 308 with the AI productivity tool software module continuing to monitor for this input.

Where, at block 310, the AI productivity tool software module does detect and receive user-query input, the method 300 continues to block 312 with the user-query input being transmitted to an AI productivity tool subagent and PAN device preferences AI software application, via an AI productivity tool plug-in being executed by the hardware processor of the information handling system. In an embodiment, the AI productivity tool subagent may provide AI productivity services as described herein. In the embodiments herein, the user-query input may include audio input received from, for example, the microphone. In another embodiment, the user-query input may include text input by the user by the keyboard.

At block 314, the method 300 also includes the hardware processor executing computer-readable program code instructions of a PAN device preferences AI software application or the AI productivity tool subagent to direct the execution of one or more ML model algorithms to identify a plurality of capabilities responsive to the user-query input, the location data, identification of PAN devices and configurations, and the historic usage information. In an embodiment, the execution of the computer-readable program code instructions of the PAN device preferences AI software application by the hardware processor or any other hardware processing device accumulates user query input, the historic data, the location data, and data related to available devices (e.g., PAN devices) within the workspace and selects among a plurality of available ML module algorithms maintained within a ML model algorithm database for use with execution of a plurality of AI productivity tool-enablable software applications according to another embodiment of the present disclosure. As described herein, the computer-readable program code instructions of the PAN device preferences AI software application and AI productivity tool subagent as well as available ML module algorithms may be executed by a hardware processor or other hardware processing resource on the information handling system thereby allowing the processes of the AI productivity tool software module to identify capabilities and respond to received user query inputs according to methods described herein to be carried out on-the-box such that a wired or wireless network connection to a network is not necessary for operation of the method. In another embodiment, some modules, databases, and/or processing resources such as ML module algorithms may be maintained on a remote server such that a wired or wireless network connection can be made with these remote servers and the method may be implemented as described herein.

The AI productivity tool subagent and PAN device preferences AI software application may engage with a machine learning model requesting module to have one or more ML model algorithms loaded and executed on the hardware processor in order to, initially, determine the query intent value of a user-query input and to correlate it with a capability intent action to be conducted responsive to the received user-query inputs. In an embodiment, the execution of the computer-readable program code instructions of the AI productivity tool subagent may call an SDK module. The SDK module may include any computer-readable program code instructions that is executed by the hardware processor or other hardware processing resource to request that a ML model algorithm that may be invoked to support the identification of, in an embodiment, a capability intent action based on received user-query inputs from a user at the AI productivity tool software module.

In example embodiments herein, the ML model algorithms may include a query input-to-intent ML model algorithm that receives the user-query input, and with an embedding algorithm generates a vectorized query intent value for the user-query input for later correlation with a capability intent value. In embodiments where the user-query input is in audio form, the AI productivity tool subagent may invoke the execution of a speech-to-text ML model algorithm to initially convert this audio into text for use with the query input-to-intent ML model algorithm to generate the vectorized query intent value for the user-query input for later correlation with a capability intent value as described herein.

In an example embodiment, the ML model algorithms may also include a query intent-to-capability matching ML model algorithm. The query intent-to-capability matching ML model algorithm receives the vectorized query intent value from the execution of the query input-to-intent ML model algorithm as input and then matches the vectorized query intent value to a vectorized capability intent value associated with the AI productivity tool-enablable software application via a similarity correlation algorithm for lexical or semantic matching to identify a responsive capability that can serve as the capability intent action responsive to a user-query input. In an embodiment, the responsive capability may include invoking the PAN device preferences AI software application as part of the execution of the AI productivity tool subagent. In embodiments of the present disclosure, the responsive capabilities also may include capabilities associated with one or more other AI productivity tool-enablable software applications. Various responsive capabilities may be executed according to embodiments herein and include plural processes to identify a workspace for the user. Other various responsive capabilities may execute to identify, operably couple, and configure identified PAN devices within a workspace automatically to respond to the user query input without substantial additional input from the user in embodiments of the present disclosure.

It is appreciated that the selected ML model algorithms for a similar or common identified AI productivity-tool operation type may satisfy an interface contract requested by the AI productivity tool subagent such that the query intent value from the user-query inputs may be interpreted and an available capability associated with one of the plurality of AI productivity tool-enablable software applications as the capability intent action can be matched to the user's query input. The interface contract described herein defines the requirements that selected ML model algorithms are to have in order to be able receive a specific type of input from the AI productivity tool software module, the AI productivity tool subagent, or any AI productivity tool-enablable software application and to provide a specific type of output to the AI productivity tool subagent, the AI productivity tool software module, and/or AI productivity tool-enablable software applications. In an embodiment, the interface contract is generated by an AI productivity proxy API invoked by the SDK module in order to identify the similar or common productivity-tool operation type ML model algorithms that provides the appropriate output to the AI productivity tool subagent.

Examples of inputs to the PAN device preferences AI software application of the AI productivity tool subagent and ML model algorithms for matching to responsive capabilities include the various location data, PAN device data, tracked information handling system usage data, telemetry data on configurations of the information handing system and PAN devices, or connectivity and security policy data in addition to the user query input. In embodiments, this plurality of inputs to the ML model algorithms of the PAN device preferences AI software application of the AI productivity tool subagent are executed to conduct a semantic matching to capabilities of one or more AI productivity tool-enablable software applications to automatically identify a workspace and PAN devices therein that meet the user's query input request and usage tendencies and automatically establish operable coupling to those PAN devices in embodiments herein. This may further include execution of responsive capabilities to ensure compliance with logical trust relationship security requirements as well as conducting pre-pairing and other measures to establish operative coupling between the information handling system in the new workspace and the identified PAN devices therein.

At block 316, the method 300 includes determining if any PAN devices within the workspace have been detected. At block 316 where no PAN devices have been detected, the method continues to block 324 as described herein. Where one or more PAN devices are detected, the method 300 continues to block 318.

At block 318, the method 300 includes determining if the detected and available PAN devices support appropriate levels of security communication protocols to operatively couple the PAN devices to the information handling system. As described herein, a capability may be identified at block 314 that is associated with the environment device detection and policy software application that identifies communication policies associated with any of these PAN devices within the workspace and established communication between those PAN devices and the information handling system using appropriate and secure methods. These PAN device communication policies may establish security requirements needed to pre-pair with the PAN devices identified in an embodiment. In further embodiments, the PAN device communication polices also establish security policies that must be satisfied for the information handling system 100, the user's security level, the tasks executed by the user, the location, and the PAN devices in embodiments herein. Indeed, execution of the environment device detection and policy software application may cause the environment device detection and policy software application to dictate the terms, conditions, and policies, such as required logical trust relationship and security requirements, under which communication is established between the PAN devices and the information handling system. This may include imposing stricter or more (or less) expansive security protocols in various embodiments.

Without the necessary security protocols being met, the environment device detection and policy software application may prevent the operative coupling of the information handling system to one or more PAN devices at block 320 in response to the user query input. In such an embodiment an error message may be displayed to the user. In other embodiments, method may return to block 308 to determine that further or more expanded logical trust relationship security processes must be executed as a responsive capability before operative coupling is permitted as a responsive capability intent action to the user query input. Here the method 300 continues to block 324 as described herein.

In some embodiments, returning to block 318 where the communication policies associated with the PAN devices are not sufficient to secure proper security operations at block 320, the environment device detection and policy software application may provide execution of capability processes for expanded security policies used to dynamically adjust security protocols to be used to operatively couple the PAN devices to the information handling system such as requiring Wi-Fi protected access 2 (WPA2) and WPA3 protocols that require shared encryption keys and handshake mechanisms that prevent offline passkey attacks. This security adjustment may be executed on the fly as a responsive capability at block 318 in an embodiment. In other embodiments at 320, the method may then return to block 308 for initiation of such a capability to dynamically adjust security protocols in another round of execution of the PAN device preferences AI software application of the AI productivity tool subagent for establishing a logical trust relationship and operative coupling with one or more PAN connected devices in a workspace for the information handling system. Either way, this renders the PAN devices, at block 318, as appropriate for operatively coupling with the information handling system.

In another embodiment, the hardware processor may execute an additional responsive capability of the computer-readable program code instructions of an environment device detection and policy software application to receive predictive pairing credentials associated with each of the PAN devices for use in pre-pairing the PAN devices prior to establishing the trust relationship between the information handling system and one or more of the identified PAN devices. This two-step process may, in an example embodiment, be additional responsive capabilities identified by the AI productivity tool and the PAN device preferences AI software application to satisfy the communication policy requirements to be used between the PAN devices and the information handling system for establishing a logical trust relationship and operative coupling with one or more PAN connected devices in a workspace for the information handling system.

Thus, at block 322, the method 300 further includes executing those identified capabilities associated with any AI productivity tool-enable software applications to conduct capability intent actions directed to securely operatively couple the identified PAN devices to the information handling system within the workspace and configure those identified PAN devices and the information handling system. These actions may control the changes in features, settings, or other actions on the information handling system, or by communication to the PAN devices, that are directly responsive to the user-query input such as “direct me to a workspace so I can review my presentation” described in FIG. 1 or “set me up to conduct my presentation” as described in FIG. 2. Thus, the described systems and methods of executing the AI productivity tool with the PAN device preferences AI software application herein provide for the automated operatively coupling of one or more PAN devices within a workspace that best accommodates the user's use of the information handling system while also securely coupling those PAN devices to the information handling system. Still further, this process may be conducted with little or no input from the user besides the initial user-query input (e.g., “direct me to a workspace so I can review my presentation” or “set me up to conduct my presentation”).

At block 324, the method 300 includes determining if the information handling system is still initiated. Where the information handling system is still initiated, the method 300 returns to block 308 as described herein. Where the information handling system is no longer initiated, the method 300 may end here.

The blocks of the flow diagrams of FIG. 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing computer-readable code instructions of an AI productivity tool software module comprising:
a hardware processor, a data storage device, and a power management unit (PMU) to provide power to the hardware processor and the data storage device;
the hardware processor executing computer-readable program code instructions of an artificial intelligence (AI) productivity tool subagent to receive user-query input from a user;
the hardware processor executing computer-readable program code instructions to receive location data describing a current location of the information handling system and request and receive an identification of personal area network (PAN) devices at a workspace in the current location available for use by the information handling system;
the hardware processor executing computer-readable program code instructions of a historic usage software application to define historic information handling system usage patterns;
the hardware processor executing computer-readable program code instructions of a PAN device preferences AI software application to receive the location data, identification of the PAN devices, historic information handling system usage patterns describing how the user has historically used the information handling system, and the user query input;
the hardware processor executing, under direction of the PAN device preferences AI software application, a plurality of machine learning (ML) model algorithms to identify a capability intent semantically matched with the user-query input, the identification of the PAN devices, and the historic information handling system usage patterns to identify a responsive capability associated with one or more AI productivity tool-enablable software applications; and
the hardware processor to execute a responsive capability intent action, based on the identified capability intent, to automatically select and operably couple the information handling system and one or more of the identified PAN devices in response to the user query input.

2. The information handling system of claim 1 further comprising:
the hardware processor executing computer-readable program code instructions of the location detection software application to access a remote workspace environment management server to obtain a workspace identification and details describing workspace capabilities, PAN device inventory, and communication policies associated with each of the PAN devices at the workspace in the current location.

3. The information handling system of claim 1 further comprising:
the hardware processor executing computer-readable program code instructions of a PAN device detection module to detect at least one of the PAN devices accessible to the information handling system via an in-band communication channel or an out-of-band communication channel.

4. The information handling system of claim 1 further comprising:
the hardware processor executing computer-readable program code instructions of the environment device detection and policy software application to receive communication policies associated with security policies for each of the PAN devices at the workspace in the current location and, when the communication policies are not sufficient to meet security requirements of the information handling system, user, or activities of the user, block operative coupling with the PAN devices.

5. The information handling system of claim 1 further comprising:
the hardware processor executing computer-readable program code instructions of the environment device detection and policy software application to receive communication policies associated with security policies for each of the PAN devices at the workspace in the current location and, when the communication policies are not sufficient to meet security requirements of the information handling system, user, or activities of the user, execute a responsive capability to provide expanded security policies used to dynamically adjust security protocols to be used to operatively couple the PAN devices to the information handling system.

6. The information handling system of claim 1 further comprising:
the hardware processor executing computer-readable program code instructions of the environment device detection and policy software application to execute a responsive capability intent action to provide a visual recommendation to the user indicating where, within the location, the user should arrange the information handling system to operatively couple the information handling system with the identified PAN devices.

7. The information handling system of claim 1 further comprising:
the hardware processor executing computer-readable program code instructions of an environment device detection and policy software application to receive predictive pairing credentials with the communication policies associated with each of the PAN devices at the workspace in the current location for use in pre-pairing the PAN devices prior to securely establishing the operative coupling between the information handling system and one or more of the identified PAN devices.

8. The information handling system of claim 1, wherein the location data includes data describing physical layouts of PAN devices within the workspace that have varying levels of privacy within the current location.

9. A method of automatically selecting and operably coupling an information handling system with personal area network (PAN) devices within a workspace via a user query input comprising:
executing, with a hardware processor executing computer-readable program code instructions of an artificial intelligence (AI) productivity tool subagent to receive user-query input from a user;
executing, with the hardware processor, computer-readable program code instructions of an environment device detection and policy software application to receive location data describing a current location of the information handling system and an identification of PAN devices available at the current location for use by the information handling system;
executing, with the hardware processor, computer-readable program code instructions of a historic usage software application to track and log historic information handling system usage patterns describing how the user has historically used the information handling system;
executing, with the hardware processor, computer-readable program code instructions of a PAN device preferences AI software application to receive the location data, identification of PAN devices available, and the historic information handling system usage patterns; and
executing, under direction of the PAN device preferences AI software application, computer-readable program code instructions of a plurality of machine learning (ML) model algorithms to identify a capability intent semantically similarity matched with the user-query input location data, identification of PAN devices available, and the historic information handling system usage patterns, the capability intent associated with a responsive capability associated with one or more AI productivity tool-enablable software applications that can execute a responsive capability intent action; and
executing the responsive capability intent action to select and operably couple one or more of the identified PAN devices with the information handling system in response to the user query input.

10. The method of claim 9 further comprising:
executing, with the hardware processor, computer-readable program code instructions of the environment device detection and policy software application to access a remote workspace environment management server to obtain a workspace identification and data describing workspace capabilities, an inventory of the PAN devices, and communication policies associated with each of the PAN devices at a workspace in the current location.

11. The method of claim 9 further comprising:
executing, with the hardware processor, computer-readable program code instructions of an environment device detection and policy software application to receive predictive pairing credentials with the communication policies associated with each of the PAN devices at the workspace in the current location for use in pre-pairing the PAN devices prior to securely establishing the operative coupling between the information handling system and one or more of the identified PAN devices; and
executing a responsive capability to pre-pair the information handling system with at least one PAN device in the workspace.

12. The method of claim 9 further comprising:
executing, with the hardware processor, computer-readable program code instructions of the environment device detection and policy software application to receive communication policies associated with each of the PAN devices and, when the communication policies are not sufficient to secure proper security operations by the user according to security policy, the environment device detection and policy software application provides expanded security policies used to dynamically adjust security protocols to be used to operatively couple the PAN devices to the information handling system.

13. The method of claim 9 further comprising:
executing, with the hardware processor, computer-readable program code instructions of the environment device detection and policy software application to provide a visual recommendation to the user indicating where, within the location, the user should arrange the information handling system to conform to the received historic information handling system usage patterns and identified PAN devices.

14. The method of claim 9 further comprising:
executing, with the hardware processor, computer-readable program code instructions of the environment device detection and policy software application to receive communication policies associated with each of the PAN devices and, when the communication policies are not sufficient to secure proper security operations by the user according to security policy for the information handling system, the environment device detection and policy software application provides blocks operative coupling with at least one PAN device and the information handling system.

15. The method of claim 9, wherein the historic information handling system usage patterns includes identification of peripheral devices previously used with the information handling system, identification of PAN devices previously operatively coupled to the information handling system within a workspace, and peripheral devices currently operatively coupled to the information handling system.

16. The method of claim 9, wherein the location data includes data describing physical layouts of PAN devices within the current location that have varying levels of privacy within the current location.

17. An information handling system executing computer-readable code instructions of an artificial intelligence (AI) productivity tool software module comprising:
a hardware processor, a data storage device, and a power management unit (PMU) to provide power to the hardware processor and the data storage device;
the hardware processor executing computer-readable program code instructions of an AI productivity tool subagent to receive user-query input from a user;
the hardware processor executing computer-readable program code instructions to receive location data describing a current location of the information handling system and request and receive an identification of personal area network (PAN) devices and communication policies associated with each of the PAN devices at a workspace in the current location available for use by the information handling system;
the hardware processor executing computer-readable program code instructions of a historic usage software application to define historic information handling system usage patterns;
the hardware processor executing computer-readable program code instructions of a PAN device preferences AI software application to receive the location data, identification of the PAN devices, historic information handling system usage patterns describing how the user has historically used the information handling system, and the user query input;
the hardware processor executing, under direction of the PAN device preferences AI software application, a plurality of machine learning (ML) model algorithms to identify a capability intent semantically matched with the user-query input, the identification of the PAN devices, and the historic information handling system usage patterns to identify a responsive capability associated with one or more AI productivity tool-enablable software applications;
the hardware processor to execute a responsive capability intent action, based on the identified capability intent, to automatically select and operably couple the information handling system and one or more of the identified PAN devices in response to the user query input; and
the hardware processor executing computer-readable program code instructions of the environment device detection and policy software application to establish a pre-pairing logical trust relationship between the information handling system and one or more of the identified PAN devices for operative coupling based on the communication policies of the PAN devices and security requirements of the information handling system for operable coupling.

18. The information handling system of claim 17 further comprising:
the hardware processor executing computer-readable program code instructions of the location detection software application to access a remote workspace environment management server to obtain a workspace identification and details describing workspace capabilities, an inventory of the PAN devices at the workspace, and the communication policies associated with security requirements of the PAN devices within the PAN device inventory.

19. The information handling system of claim 17 further comprising:
the hardware processor executing computer-readable program code instructions of a PAN device detection module to detect PAN devices accessible to the information handling system via an in-band wireless communication channel or an out-of-band wireless communication channel to at least one PAN device.

20. The information handling system of claim 17 further comprising:
the hardware processor executing computer-readable program code instructions of the environment device detection and policy software application to provide a visual recommendation to the user as a responsive capability intent action indicating where, within the current location, the user should arrange the information handling system and operably couple to identified PAN devices in the workspace.
